(19) United States
(12) Patent Application Publication
(10) Pub. No.: US 2018/0257257 A1
(43) Pub. Date: Sep. 13, 2018

(54) Systems, Devices, and/or Methods for Splitting Logs

(71) Applicant: Michael L McCurdy, South Beloit, IL (US)

(72) Inventor: Michael L McCurdy, South Beloit, IL (US)

(21) Appl. No.: 15/456,548

(22) Filed: Mar. 12, 2017

(51) Int. Cl. B27L 7/06

(52) U.S. Cl. CPC B27L 7/06

(57) ABSTRACT

Certain exemplary embodiments can provide a system that comprises a frame. The frame comprises an object retaining base, wedge mounting surface, and a frame cylinder mounting surface. The frame cylinder mounting surface is on an opposing side of the frame than the wedge mounting surface. A cutting wedge is coupled to the wedge mounting surface of the frame.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a perspective view of an exemplary embodiment of a system, 1000;

FIG. 2 is a perspective view of an exemplary embodiment of system 1000;

FIG. 3 is a perspective view of system 1000;

FIG. 4 is a perspective view of system 1000;

FIG. 5 is a perspective view of system 1000;

FIG. 6 is a perspective view of system 1000;

FIG. 7 is a perspective view of system 1000;

FIG. 8A is a side view of system 1000;

FIG. 8B is a side view of system 1000;

FIG. 9 is a side view of system 1000;

FIG. 10 is an end view of system 1000;

FIG. 11 is a flowchart of an exemplary embodiment of a method 11000; and

### DETAILED DESCRIPTION

Certain exemplary embodiments can provide a system that comprises a frame. The frame comprises an object retaining base, wedge mounting surface, and a frame cylinder mounting surface. The frame cylinder mounting surface is on an opposing side of the frame than the wedge mounting surface. A cutting wedge is coupled to the wedge mounting surface of the frame.

Certain exemplary embodiments are utilized to split firewood. Most fireplaces and stoves that burn wood utilize wood pieces that are smaller than wood as it is cut from trees. Certain exemplary embodiments can provide an angle splitter that can pick up wood that is resting on the ground and lift the wood to an elevation that an operator can observe operations of the wood splitting system. Thus, the equipment does the lifting and splitting rather than any such activity being performed by an operator of the system. Certain exemplary embodiments are mounted with the direction of an axle on a trailer where other systems are mounted with a direction of a tongue of the trailer. The system ram and working components can move to various angles depending on the size of log to be handled and split. Certain exemplary embodiments can be backed up to a log and can start splitting the log. Certain exemplary embodiments can pick up smaller logs without adding a lift tray. An operator can leave an exemplary system hooked up to a vehicle such that the system will be conveniently positioned for other activities to be performed.

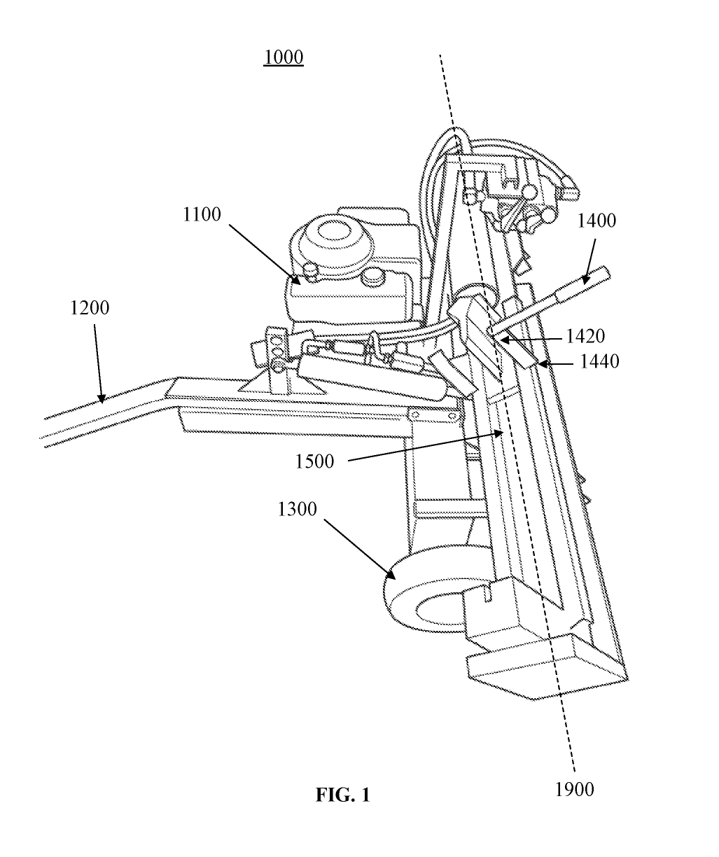

FIG. 1 is a perspective view of an exemplary embodiment of a system, 1000, which is constructed to split logs and/or other wood pieces. System 1000 can comprise:
a hydraulic system 1100 that provides energy in the form of a pressurized fluid (e.g., hydraulic fluid or air) to actuate extendible actuators (e.g., hydraulic cylinders or pneumatic cylinders) that position system 1000 relative to wood to be split and to drive a wedge through the wood when the wood is grasped by system 1000;
a tongue 1200 that can be coupled to a towing hitch, whereby system 1000 can be releasably coupled to a vehicle to change a location of system 1000;
a set of wheels 1300;
a frame 1500; and/or
a handle 1400 coupled to a handle mount 1420, handle mount 1420 coupled to a wedge mounting surface 1440 of frame 1500, handle 1400 constructed to allow a user to guide rotation of frame 1500 about a longitudinal axis 1900.

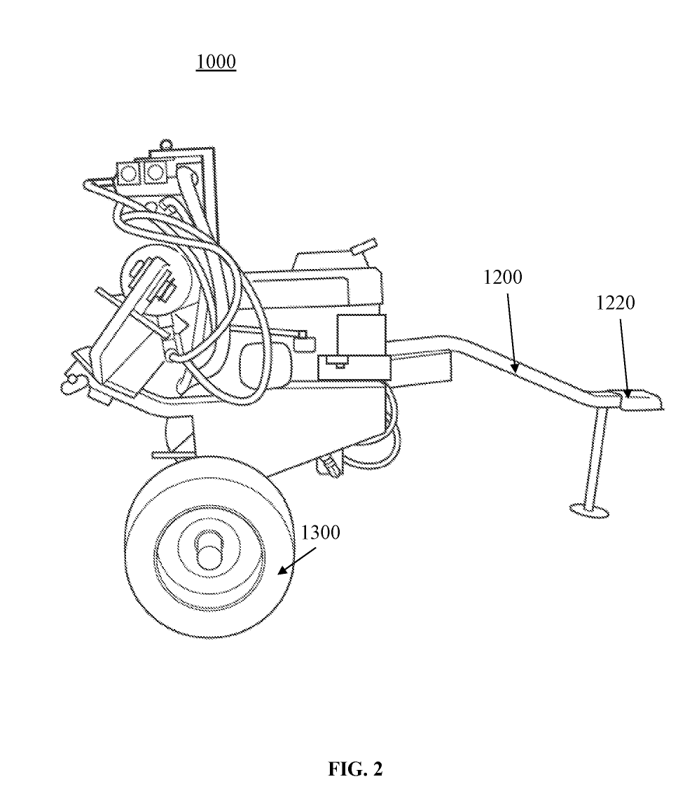

FIG. 2 is a perspective view of an exemplary embodiment of system 1000, which illustrates system components rotated to a towing orientation. Tongue 1200 is coupled to towing hitch 1220. Towing hitch 1220 can be coupled to a vehicle to, via set of wheels 1300, change the location of system 1000.

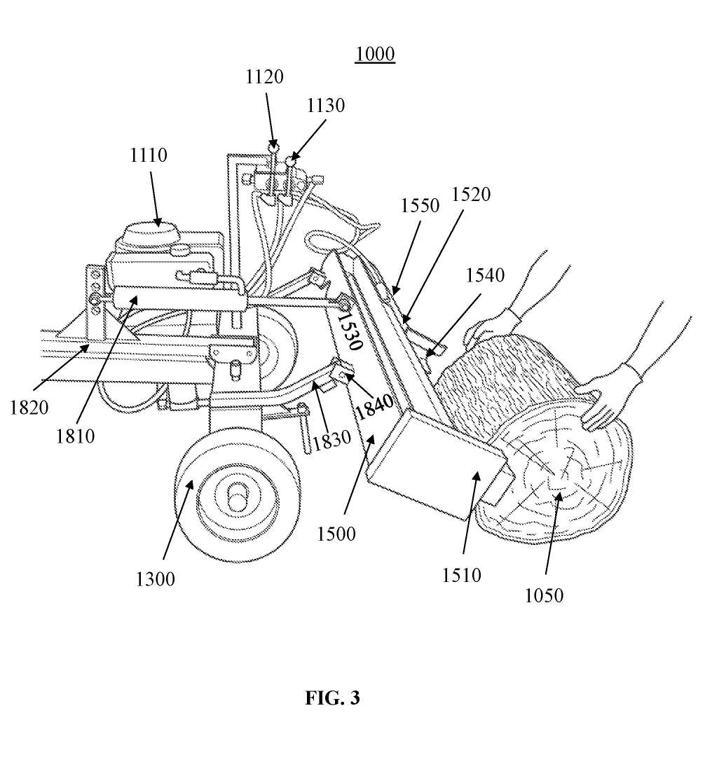

FIG. 3 is a perspective view of system 1000, which comprises:
a frame 1500 comprising:
   an object retaining base 1510;
   a wedge mounting surface 1520; and
   a frame cylinder mounting surface 1530, wherein frame cylinder mounting surface 1530 is on an opposing side of 1500 frame than wedge mounting surface 1520;
a cutting wedge 1540 coupled to wedge mounting surface 1520 of frame 1500;
a wedge cylinder 1550 coupled to wedge mounting surface 1520 of frame 1500, wedge cylinder 1550 coupled to cutting wedge 1540, wherein wedge cylinder 1550 causes cutting wedge 1540 to move along longitudinal axis 1900 (see FIG. 1) of frame 1500, wherein cutting wedge 1540 is constructed to penetrate a splittable object 1050 between object retaining base 1510 of frame 1500 and cutting wedge 1540 as cutting wedge 1540 moves along longitudinal axis 1900 (see FIG. 1) of frame 1500;
a frame cylinder 1810 coupled to frame cylinder mounting surface 1530 of frame 1500, frame cylinder 1810 causes frame 1500 to rotate about longitudinal axis 1900 for frame 1500 from a rest position to a grabbing position, frame cylinder 1810 substantially retracted in the rest position, frame cylinder 1810 extended in the grabbing position;
motor 1110 provides energy to a fluid to cause frame cylinder 1810 and/or wedge cylinder 1550 to retract and extend;
a user operated frame cylinder valve 1120 that starts and stops fluid flow to frame cylinder 1810;
a user operated wedge cylinder valve 1130 that starts and stops fluid flow to wedge cylinder 1550; and/or
a frame cylinder base 1820 is coupled to frame cylinder 1810, frame cylinder base 1820 is coupled to motor 1110 that provides energy to a fluid to cause frame cylinder 1810 and/or wedge cylinder 1550 to retract and extend; frame cylinder base 1820 is coupled (e.g., releasably coupled) to frame 1500 via a pair of frame coupling arms 1830, wherein each of frame coupling arms 1830 are coupled to frame 1500 via a rotatable hinge 1840, wherein frame cylinder base 1820 is coupled to pair of wheels 1300, pair of wheels 1300 is constructed to allow system 1000 to be moved, wherein frame cylinder base 1820 is coupled to towing hitch 1220, which is coupleable to a vehicle; etc.

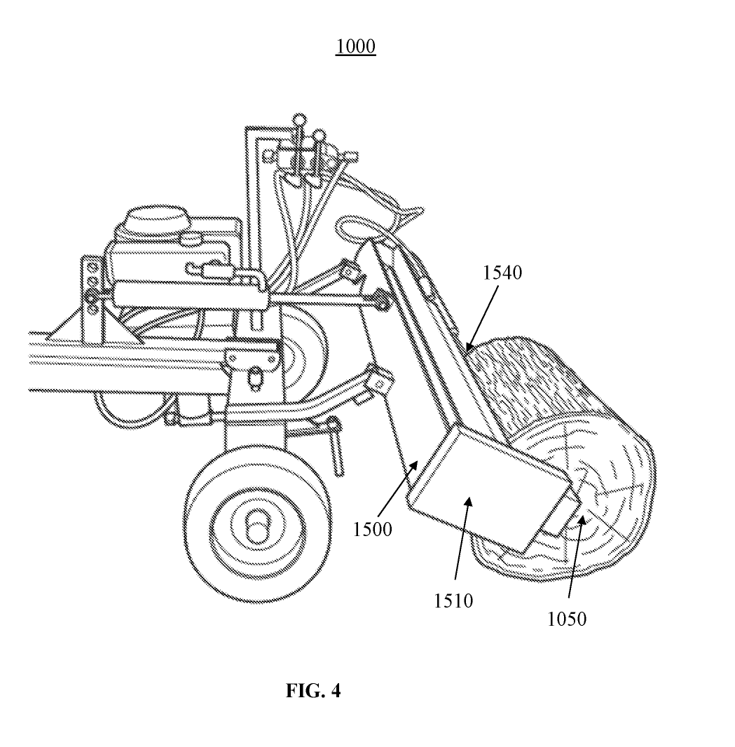

FIG. 4 is a perspective view of system 1000 in which splittable object 1050 is held between object retaining base 1510 of frame 1500 and cutting wedge 1540 as cutting wedge 1540 moves along longitudinal axis 1900 (see FIG. 1) of frame 1500.

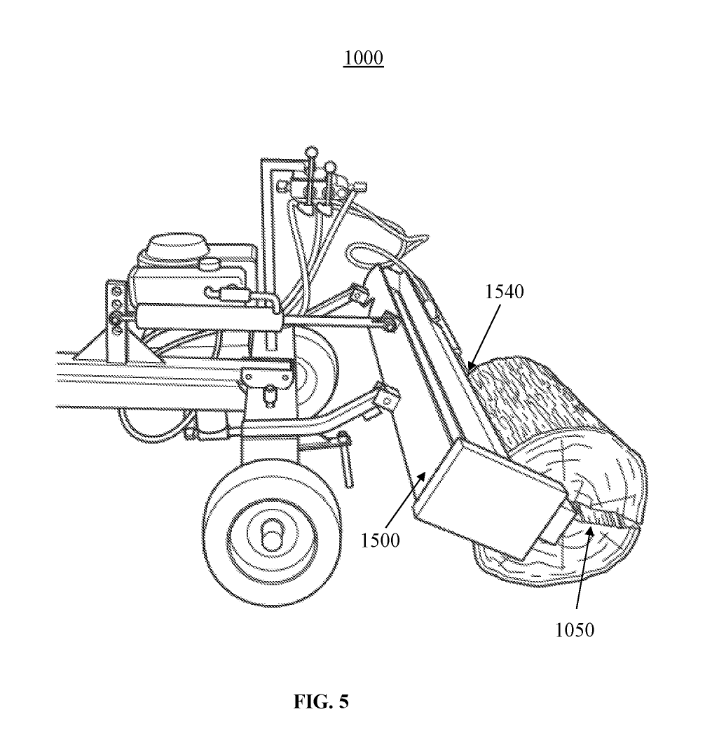

FIG. 5 is a perspective view of system 1000 in which splittable object 1050 is in the process of being split as cutting wedge 1540 moves along longitudinal axis 1900 (see FIG. 1) of frame 1500.

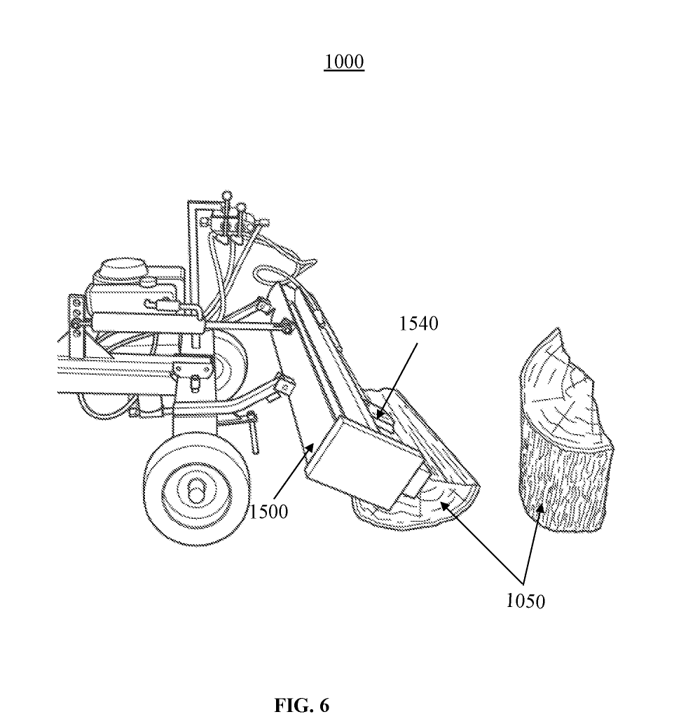

FIG. 6 is a perspective view of system 1000 in which splittable object 1050 has been split by cutting wedge 1540 moving along longitudinal axis 1900 (see FIG. 1) of frame 1500.

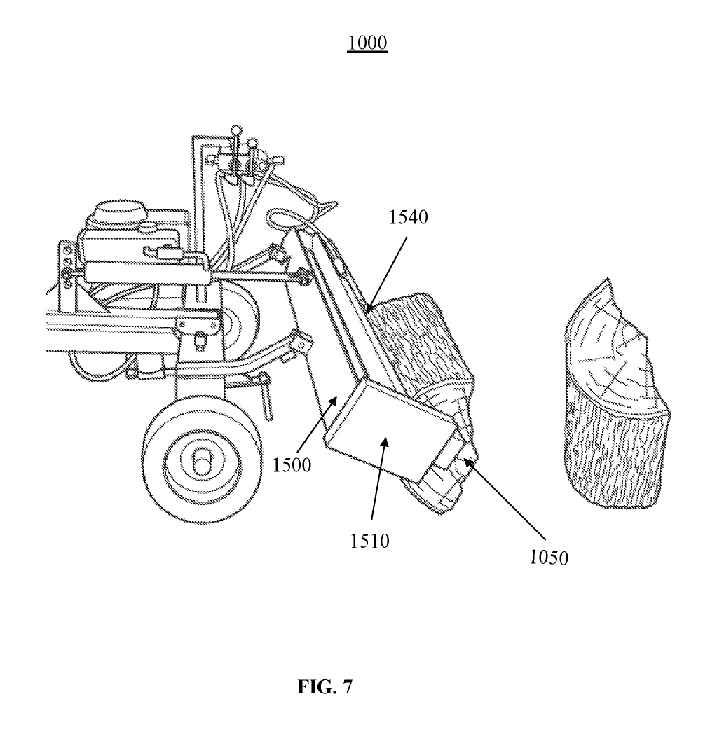

FIG. 7 is a perspective view of system 1000 illustrates a second pass of system 1000 further splitting splittable object 1050, which is shown as held between object retaining base 1510 of frame 1500 and cutting wedge 1540 as cutting wedge 1540 moves along longitudinal axis 1900 (see FIG. 1) of frame 1500.

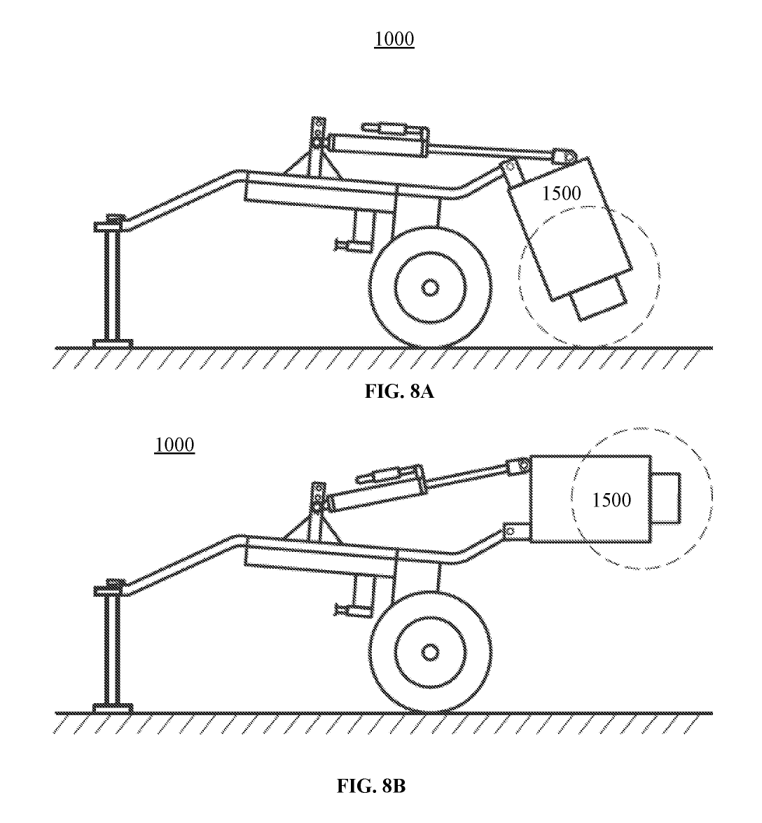

FIG. 8A is a side view of system 1000 with frame 1500 rotated to pick up a splittable object.

FIG. 8B is a side view of system 1000 with frame 1500 rotated to a splitting position after picking up a splittable object.

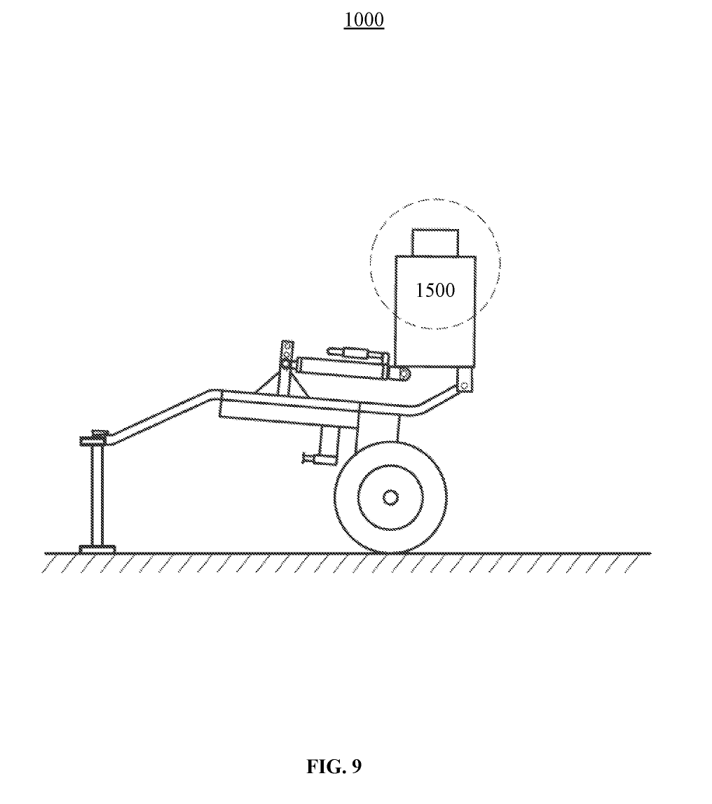

FIG. 9 is a side view of system 1000 with frame 1500 rotated to a position where system 1000 can be relocated by towing system 1000 with a vehicle.

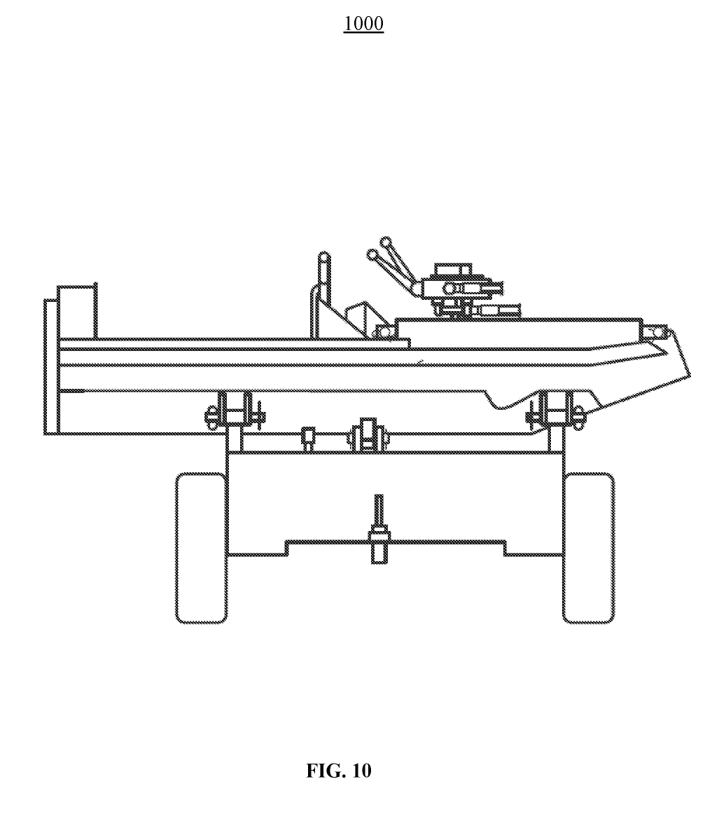

FIG. 10 is an end view of system 1000.

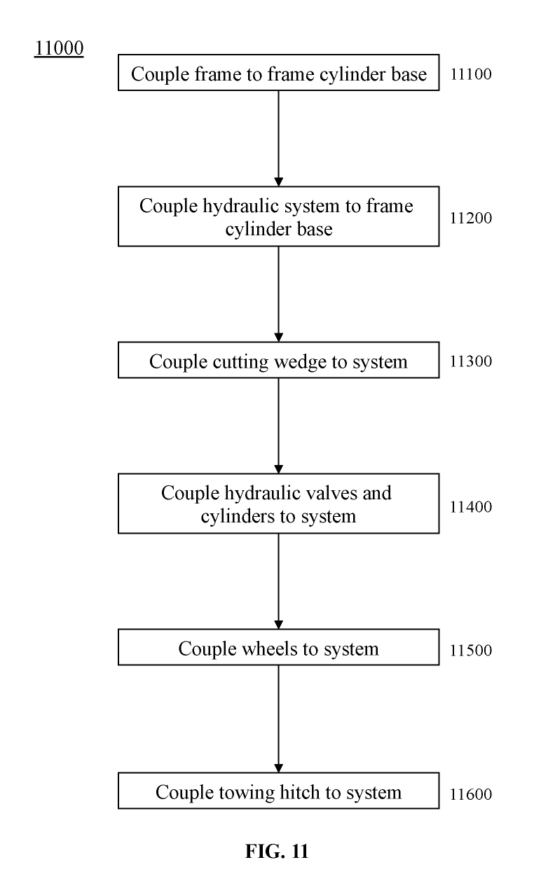

FIG. 11 is a flowchart of an exemplary embodiment of a method 11000. At activity 11100, a frame is coupled to a frame cylinder base. At activity 11200, a hydraulic system comprising a motor is coupled to the frame cylinder base. At activity 11300, a cutting wedge is coupled to the system. At activity 11400, hydraulic valves and cylinders are coupled to the system. At activity 11500, wheels are coupled to the system. At activity 11600, a towing hitch can be coupled to the system.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.

a—at least one.

activity—an action, act, step, and/or process or portion thereof

adapter—a device used to effect operative compatibility between different parts of one or more pieces of an apparatus or system.

allow—to permit or facilitate.

and/or—either in conjunction with or in alternative to.

apparatus—an appliance or device for a particular purpose.

arm—a member that couples frames together.

associate—to join, connect together, and/or relate.

can—is capable of, in at least some embodiments.

cause—to produce an effect.

comprising—including but not limited to.

configure—to make suitable or fit for a specific use or situation.

connect—to join or fasten together.

constructed to—made to and/or designed to.

convert—to transform, adapt, and/or change.

coupleable—capable of being joined, connected, and/or linked together.

coupling—linking in some fashion.

create—to bring into being.

cutting wedge—an object that tapers to a thin edge and is used for splitting something (e.g., wood, rocks, etc.).

define—to establish the outline, form, or structure of

device—a machine, manufacture, and/or collection thereof.

energy—a capacity to do work.

extend—to draw out in length.

fluid flow—a movement of a liquid from one location to another.

frame—a structure that supports something.

frame coupling arms—a projecting part that couples a frame to a frame cylinder base.

frame cylinder—a mechanical actuator that is used to give a unidirectional force through a unidirectional stroke and is coupled to a frame.

frame cylinder base—a surface to which a frame cylinder is mounted.

frame cylinder mounting surface—an outer layer of a frame that is coupled to a frame cylinder.

generate—to create, produce, give rise to, and/or bring into existence.

grabbing position—a position in which a cutting wedge is generally used and the wedge cylinder is at least partially extended.

guide—to assist an object to move in a certain path.

handle—a part used by a human to hold or operate something.

handle mount—a surface that holds a handle in place.

hinge—a jointed or flexible coupler on which a component turns relative to another component.

install—to connect or set in position and prepare for use.

longitudinal axis—a line along a longest dimension of an object that passes through the object's center of gravity.

may—is allowed and/or permitted to, in at least some embodiments.

method—a process, procedure, and/or collection of related activities for accomplishing something.

motor—a machine that causes motion.

move—to traverse from a first location to a second location.

object—something that is visible, tangible, and stable in form.

object retaining base—a component that has a surface that resists motion of an object parallel to an axis that is substantially perpendicular to the surface when the object is placed between that surface and a cutting wedge.

operate—to control an actuation.

opposing—positioned opposite something else.

pair—a set of two.

penetrate—to enter or pass through something.

plurality—the state of being plural and/or more than one.

predetermined—established in advance.

provide—to furnish, supply, give, and/or make available.

receive—to get, take, acquire, and/or obtain.

repeatedly—again and again; repetitively.

rest position—a position in which a cutting wedge is generally not used and the wedge cylinder is substantially retracted.

retract—to draw in in length.

rotate—to turn about an axis.

select—to make a choice or selection from alternatives.

set—a related plurality.

split—to divide into at least two parts.

store—to place, hold, and/or retain.

substantially—to a great extent or degree.

support—to bear the weight of, especially from below.

system—a collection of mechanisms, devices, machines, articles of manufacture, processes, data, and/or instructions, the collection designed to perform one or more specific functions.

trailer hitch—a device constructed to be coupled to the chassis of a vehicle to allow towing.

user—a person that uses a device.

valve—a mechanical device via which the flow of a liquid may be started, stopped, or regulated by a movable part that opens, shuts, or partially obstructs one or more ports or passageways.

vehicle—a conveyance moving on wheels, runners, tracks, or the like, as cart, sled, automobile, truck, pickup truck, jeep, sport utility vehicle, or tractor, etc.

via—by way of and/or utilizing.

wedge cylinder—a mechanical actuator that is used to give a unidirectional force through a unidirectional stroke and is coupled to a cutting wedge.

wedge mounting surface—an outer layer of a frame that is coupled to a cutting wedge.

wheel—a round component that rotates.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system, comprising:
a frame comprising:
an object retaining base;
a wedge mounting surface; and
a frame cylinder mounting surface, wherein the frame cylinder mounting surface is on an opposing side of the frame than the wedge mounting surface;
a cutting wedge coupled to the wedge mounting surface of the frame;
a wedge cylinder coupled to the wedge mounting surface of the frame, the wedge cylinder coupled to the cutting wedge, wherein the wedge cylinder causes the cutting wedge to move along a longitudinal axis of the frame, wherein the cutting wedge is constructed to penetrate a splittable object between the object retaining base of the frame and the cutting wedge as the cutting wedge moves along the longitudinal axis of the frame;
a frame cylinder coupled, via a single fastener through a single ear, to the frame cylinder mounting surface of the frame, the single ear coupled directly to the frame, the frame substantially lacking any component between the single ear and an H-beam of the frame, the frame cylinder being the sole frame cylinder in said system, the frame cylinder causing the frame to rotate about the longitudinal axis for the frame from a rest position to a grabbing position, the frame cylinder substantially retracted in the rest position, the frame cylinder extended in the grabbing position.

2. The system of claim 1, further comprising:
a handle coupled to a handle mount, the handle mount coupled to the wedge mounting surface of the frame, the handle constructed to allow a user to guide rotation of the frame about the longitudinal axis.

3. The system of claim 1, further comprising:
a motor that provides energy to a fluid to cause the frame cylinder and the wedge cylinder to retract and extend.

4. The system of claim 1, further comprising:
a user operated frame cylinder valve that starts and stops fluid flow to the frame cylinder.

5. The system of claim 1, further comprising:
a user operated wedge cylinder valve that starts and stops fluid flow to the wedge cylinder.

6. The system of claim 1, further comprising:
a frame cylinder base coupled to the frame cylinder, the frame cylinder base coupled to a motor that provides energy to a fluid to cause the frame cylinder and the wedge cylinder to retract and extend.

7. The system of claim 1, further comprising:
a frame cylinder base coupled to the frame via a pair of frame coupling arms.

8. The system of claim 1, further comprising:
a frame cylinder base releasably coupled to the frame via a pair of frame coupling arms, wherein each of the frame coupling arms are coupled to the frame via a rotatable hinge, wherein neither of the frame coupling arms are coupled to any actuator.

9. The system of claim 1, further comprising:
a frame cylinder base releasably coupled to the frame via a pair of frame coupling arms, wherein the frame cylinder base is coupled to a pair of wheels, the pair of wheels constructed to allow the system to be moved.

10. The system of claim 1, further comprising:
a frame cylinder base releasably coupled to the frame via a pair of frame coupling arms, wherein the frame cylinder base comprises a pair of wheels, the pair of wheels constructed to allow the system to be moved, wherein the frame cylinder base is coupled to a towing hitch that is coupleable to a vehicle.
